(19) United States
(12) Patent Application Publication
(10) Pub. No.: US 2025/0308035 A1
(43) Pub. Date: Oct. 2, 2025

(54) IMAGE PROCESSING DEVICE, IMAGE PROCESSING METHOD, AND IMAGE PROCESSING PROGRAM

(71) Applicant: FUJIFILM CORPORATION, Tokyo (JP)

(72) Inventors: Jun NAKABAYASHI, Tokyo (JP); Ko OKADA, Tokyo (JP); Hirotaka ITO, Tokyo (JP); Takeshi UNEMURA, Tokyo (JP)

(21) Appl. No.: 19/079,472

(22) Filed: Mar. 14, 2025

(30) Foreign Application Priority Data
Mar. 26, 2024 (JP) 2024-050488

(51) Int. Cl. G06T 7/20; G06F 17/13

(52) U.S. Cl. CPC G06T 7/20; G06F 17/13; G06T 2207/20036; G06T 2207/20081

(57) ABSTRACT

An image processing device including a processor, wherein the processor is configured to: use a learning model that is a learning model for generating, from a flow velocity image representing a spatial distribution of a flow velocity vector of fluid in a structure of a living body, a flow velocity estimation image having a higher resolution than the flow velocity image and a morphological image representing a morphology of the structure and that is trained based on a loss function using at least information on a physical law of the fluid and the flow velocity image, to generate the flow velocity estimation image and the morphological image from the flow velocity image.

### CROSS-REFERENCE TO RELATED APPLICATIONS

This application claims priority from Japanese Application No. 2024-050488, filed on Mar. 26, 2024, the entire disclosure of which is incorporated herein by reference.

### BACKGROUND

### Technical Field

The present disclosure relates to an image processing device, an image processing method, and an image processing program.

### Related Art

In the related art, an analysis of a flow of fluid in a structure of a living body using a medical image has been performed. An analysis result of the flow of the fluid is used for visualization of the flow of the fluid, quantification of an indicator for a diagnosis and a treatment, and the like.

For example, in the analysis of the blood flow, a four-dimensional (4D) flow method of measuring, in four dimensions, an actual blood flow is used. In the 4D flow, a three-dimensional PC-MRI image acquired by imaging the blood vessel over a plurality of time phases (phases) using a three-dimensional cine phase contrast-magnetic resonance imaging (PC-MRI) method is generally used. The 4D flow is a method of deriving a flow velocity vector representing a blood flow velocity for each region of the blood vessel from the three-dimensional PC-MRI image and dynamically displaying the flow velocity vector in accordance with a flow of time.

In addition, in the 4D flow, for example, an image for specifying a structure of the blood vessel may be captured separately from the PC-MRI image by magnetic resonance angiography (MRA). This is because it is difficult to specify a structure of a thin blood vessel (for example, a cerebral artery and a coronary artery) with only the PC-MRI image due to a resolution constraint. In this case, the registration between the PC-MRI image and the MRA image is required. In a case in which the blood flow and the structure of the blood vessel are spatially and temporally matched, it is also possible to quantify an indicator such as wall shear stress (WSS) indicating a frictional stimulus of the blood flow applied to a vascular wall.

In addition, for example, JP2022-123809A discloses a medical information processing device that determines 3D physical quantity data from measured 2D physical quantity data by using a model for converting 2D physical data into 3D physical data, the model being a model that complies with a physical law. As the 2D physical data, a two-dimensional blood flow velocity obtained by the PC-MRI is disclosed. As the 3D physical data, a three-dimensional blood flow velocity and a pressure field are disclosed.

In addition, for example, Maziar Raissi et al., “Hidden fluid mechanics: Learning velocity and pressure fields from flow visualizations”, Science 367, 1026-1030, January 2020 discloses that a simulation of a blood flow is performed by using a physics-informed neural network (PINNs) that has learned a governing equation of a physical law.

In recent years, there has been an increasing demand for the accuracy of the analysis result for the analysis of the flow of fluid in the structure of the living body. However, in the related art, there is a case in which the accuracy of the analysis result is not sufficient. For example, in the analysis of the blood flow, in a case in which the image capturing for specifying the structure of the blood vessel, such as the MRA image, is not performed, the structure of the blood vessel cannot be specified with high accuracy, and thus the quantification accuracy of the indicator such as the WSS is not sufficient. In addition, for example, in a case in which the MRA image is additionally captured, the accuracy of the analysis result may be reduced due to misregistration that occurs in a case in which the registration between the PC-MRI image and the MRA image is performed.

### SUMMARY

The present disclosure provides an image processing device, an image processing method, and an image processing program, which can analyze a flow of fluid in a structure of a living body with high accuracy.

A first aspect of the present disclosure relates to an image processing device comprising: at least one processor, in which the processor is configured to: use a learning model that is a learning model for generating, from a flow velocity image representing a spatial distribution of a flow velocity vector of fluid in a structure of a living body, a flow velocity estimation image having a higher resolution than the flow velocity image and a morphological image representing a morphology of the structure and that is trained based on a loss function using at least information on a physical law of the fluid and the flow velocity image, to generate the flow velocity estimation image and the morphological image from the flow velocity image.

In the above-described aspect, the information on the physical law of the fluid may be a differential equation as a governing equation describing a motion of the fluid.

In the above-described aspect, the differential equation may be Navier-Stokes equations.

In the above-described aspect, the loss function may be changed in accordance with the number of iterations in training of the learning model.

In the above-described aspect, the learning model may be trained based on a first loss function representing an error between the flow velocity image and the flow velocity estimation image, and a second loss function representing a goodness of fit of the flow velocity estimation image to a governing equation describing a motion of the fluid.

In the above-described aspect, the learning model may be trained using a weighted sum of the first loss function and the second loss function, and a weight of each of the first loss function and the second loss function in the weighted sum is changed in accordance with the number of iterations in training.

In the above-described aspect, at least one of the weight of the first loss function or the weight of the second loss function may be changed so that an influence of the second loss function is increased as the number of iterations is increased.

In the above-described aspect, the learning model may be trained based on the first loss function, the second loss function, and a third loss function representing a goodness of fit of the flow velocity estimation image, which corresponds to a wall position of the structure represented by the morphological image, to a boundary condition in the governing equation describing the motion of the fluid.

In the above-described aspect, the learning model may be trained using a weighted sum of the first loss function, the second loss function, and the third loss function, and a weight of each of the first loss function, the second loss function, and the third loss function in the weighted sum is changed in accordance with the number of iterations in training.

In the above-described aspect, at least one of the weight of the first loss function, the weight of the second loss function, or the weight of the third loss function may be changed so that an influence of at least one of the second loss function or the third loss function is increased as the number of iterations is increased.

In the above-described aspect, the learning model may include a first learning model that is a first learning model for generating the flow velocity estimation image from the flow velocity image and that is trained based on the loss function using at least the information on the physical law of the fluid and the flow velocity image, and a second learning model for generating the morphological image from at least one of the flow velocity image or the flow velocity estimation image.

In the above-described aspect, the structure may be a blood vessel, and the fluid may be blood.

In the above-described aspect, the blood vessel may be at least one of a cerebral artery, a carotid artery, a coronary artery, a thoracic aorta, or an abdominal aorta.

In the above-described aspect, the flow velocity image may be a three-dimensional image acquired by imaging the blood vessel using a three-dimensional cine phase contrast-magnetic resonance imaging method.

In the above-described aspect, the processor may be configured to: derive a wall shear stress for each region in the morphological image based on the flow velocity estimation image and the morphological image.

In the above-described aspect, the processor may be configured to: generate an image in which magnitude of the wall shear stress for each region in the morphological image is visualized.

In the above-described aspect, the processor may be configured to: use the learning model to further generate a pressure image representing a distribution of a pressure of the fluid in the structure from the flow velocity image, and derive fractional flow reserve for each region in the morphological image based on the pressure image and the morphological image.

In the above-described aspect, the processor may be configured to: generate an image in which magnitude of the fractional flow reserve for each region in the morphological image is visualized.

A second aspect of the present disclosure relates to an image processing method executed by a computer, the image processing method including: using a learning model that is a learning model for generating, from a flow velocity image representing a spatial distribution of a flow velocity vector of fluid in a structure of a living body, a flow velocity estimation image having a higher resolution than the flow velocity image and a morphological image representing a morphology of the structure and that is trained based on a loss function using at least information on a physical law of the fluid and the flow velocity image, to generate the flow velocity estimation image and the morphological image from the flow velocity image.

A third aspect of the present disclosure relates to an image processing program causing a computer to execute a process including: using a learning model that is a learning model for generating, from a flow velocity image representing a spatial distribution of a flow velocity vector of fluid in a structure of a living body, a flow velocity estimation image having a higher resolution than the flow velocity image and a morphological image representing a morphology of the structure and that is trained based on a loss function using at least information on a physical law of the fluid and the flow velocity image, to generate the flow velocity estimation image and the morphological image from the flow velocity image.

According to the above-described aspects, the image processing device, the image processing method, and the image processing program of the present disclosure can analyze the flow of the fluid in the structure of the living body with high accuracy.

### BRIEF DESCRIPTION OF THE DRAWINGS

FIG. 1 is a schematic configuration diagram of an analysis system.

FIG. 2 is a block diagram showing an example of a hardware configuration of an image processing device.

FIG. 3 is a block diagram showing an example of a functional configuration of the image processing device.

FIG. 4 is a diagram showing an example of a three-dimensional image captured by PC-MRI.

FIG. 5 is a diagram showing an example of a schematic configuration of an analysis model.

FIG. 6 is a diagram showing an example of a detailed configuration of the analysis model.

FIG. 7 is a diagram showing an example of a screen displayed on a display.

FIG. 8 is a flowchart showing an example of image processing.

FIG. 9 is a diagram for describing an application example of a Windkessel model.

FIG. 10 is a diagram showing an example of a fluid image and a morphological image in a comparative example.

### DETAILED DESCRIPTION

Hereinafter, an example of an embodiment of the present disclosed technology will be described with reference to the accompanying drawings. The same or equivalent components and parts in the respective drawings are denoted by the same reference numerals, and the duplicated description will be omitted. Further, dimensional ratios in the drawings are exaggerated for convenience of description, and may be different from the actual ratios.

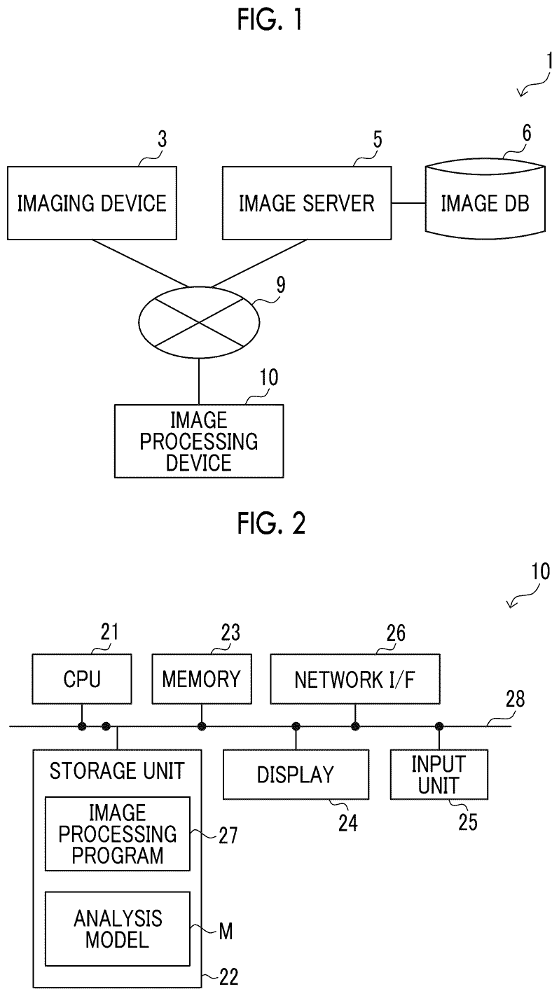

First, an example of a configuration of an analysis system 1 according to the present embodiment will be described with reference to FIG. 1. The analysis system 1 according to the present embodiment is a system for analyzing a flow of fluid in a structure of a living body. Hereinafter, as an example, an example will be described in which the structure is a blood vessel, and the fluid is blood. The blood vessel may be, for example, at least one of a cerebral artery, a carotid artery, a coronary artery, a thoracic aorta, or an abdominal aorta.

The analysis system 1 includes an image processing device 10, an imaging device 3, an image server 5, and an image database (DB) 6. The image processing device 10, the imaging device 3, and the image server 5 are connected to each other in a communicable state via a wired or wireless network 9. The network 9 is, for example, a network, such as a local area network (LAN) and a wide area network (WAN).

The imaging device 3 is a device (modality) for generating a flow velocity image representing a spatial distribution of a flow velocity vector of the fluid in the structure of the living body. An example of the imaging device 3 is an MRI device that images a blood vessel over a plurality of time phases (phases) via a three-dimensional cine phase contrast-magnetic resonance imaging (PC-MRI) method. The flow velocity image, which is generated by the imaging device 3, is transmitted to the image server 5.

The image server 5 is a general-purpose computer in which a software program that provides a function of a database management system is installed. The image server 5 is connected to the image DB 6. In a case in which the image server 5 receives a registration request for the flow velocity image from the imaging device 3, the image server 5 prepares the flow velocity image in a format for a database and registers the flow velocity image in the image DB 6. In addition, in a case in which the image server 5 receives a viewing request from the image processing device 10, the image server 5 searches for the flow velocity image registered in the image DB 6 and transmits the searched flow velocity image to the image processing device 10.

The image DB 6 is implemented by, for example, a storage medium such as a hard disk drive (HDD), a solid-state drive (SSD), or a flash memory. The flow velocity image acquired by the imaging device 3 and the metadata related to the flow velocity image are registered in the image DB 6 in association with each other. It should be noted that the connection form between the image server 5 and the image DB 6 is not particularly limited, and may be a form connected by a data bus or a form of being connected to each other via a network such as a network attached storage (NAS) and a storage area network (SAN).

The metadata may include, for example, identification information such as an image identification (ID) for identifying the flow velocity image, a subject ID for identifying a subject, and an examination ID for identifying an examination. In addition, for example, the metadata may include information on the subject, such as a name, a date of birth, age, and gender of the subject.

In addition, for example, the metadata may include information on the imaging, such as an imaging method, an imaging condition, an imaging purpose, and an imaging date and time related to the capturing of the flow velocity image. The “imaging method” and the “imaging condition” are, for example, a type of the imaging device 3, a manufacturing company, an imaging part, an imaging protocol, an imaging sequence, an imaging technique, whether or not a contrast medium is used, and a resolution. The metadata may be acquired, for example, from a known external information system, such as a radiology information system (RIS) and a hospital information system (HIS).

It should be noted that each device included in the analysis system 1 may be disposed in the same facility (for example, a hospital) or disposed in different facilities. In addition, each number of devices included in the analysis system 1 is not particularly limited, and each device may be configured by a plurality of devices having the same function.

The image processing device 10 is a device for analyzing the flow of the fluid with higher accuracy based on the flow velocity image acquired by the imaging device 3. Hereinafter, an example of a configuration of the image processing device 10 according to the present embodiment will be described.

First, an example of a hardware configuration of the image processing device 10 will be described with reference to FIG. 2. The image processing device 10 includes a central processing unit (CPU) 21, a non-volatile storage unit 22, and a memory 23 as a temporary storage area. Further, the image processing device 10 includes a display 24, an input unit 25, and a network interface (I/F) 26. The CPU 21, the storage unit 22, the memory 23, the display 24, the input unit 25, and the network I/F 26 are connected to each other via a bus 28, such as a system bus and a control bus, so that various types of information can be exchanged.

The storage unit 22 is implemented by, for example, a storage medium such as an HDD, an SSD, or a flash memory. An image processing program 27 in the image processing device 10 is stored in the storage unit 22. The CPU 21 reads out the image processing program 27 from the storage unit 22, loads the image processing program 27 in the memory 23, and executes the loaded image processing program 27. The CPU 21 is an example of a processor of the present disclosure. An analysis model M for analyzing the flow of the fluid is stored in the storage unit 22 (details will be described later).

The display 24 is, for example, a liquid crystal display, and displays various types of information. The input unit 25 includes a pointing device such as a mouse and a keyboard, and is used to perform various types of input to the image processing device 10. It should be noted that the display 24 may be configured by a touch panel and used as the input unit 25.

The network I/F 26 is an interface for communicating with an external device, such as the imaging device 3 and the image server 5, via the network 9. For the communication, for example, a wired communication standard, such as Ethernet (registered trademark) or fiber distributed data interface (FDDI), or a wireless communication standard, such as 4G, 5G, or Wi-Fi (registered trademark), is used. As the image processing device 10, for example, a personal computer, a server computer, a smartphone, a tablet terminal, a wearable terminal, or the like can be applied as appropriate.

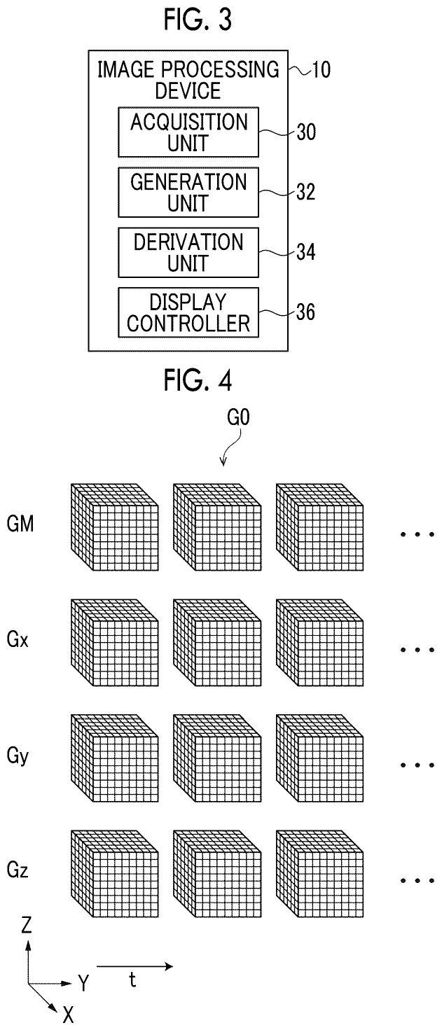

Hereinafter, an example of a functional configuration of the image processing device 10 will be described with reference to FIG. 3. The image processing device 10 includes an acquisition unit 30, a generation unit 32, a derivation unit 34, and a display controller 36.

In a case in which the CPU 21 executes the image processing program 27, the CPU 21 functions as each of the functional units of the acquisition unit 30, the generation unit 32, the derivation unit 34, and the display controller 36.

The acquisition unit 30 acquires the flow velocity image representing the spatial distribution of the flow velocity vector of the fluid in the structure of the living body from the imaging device 3 and/or the image server 5. The flow velocity image is, for example, a three-dimensional image (hereinafter, referred to as a PC-MRI image) acquired by imaging the blood vessel over a plurality of time phases (phases) via the PC-MRI.

FIG. 4 shows an example of a PC-MRI image G0. The PC-MRI image G0 includes magnitude data GM, phase data Gx in an X-axis direction, phase data Gy in a Y-axis direction, and phase data Gz in a Z-axis direction. The magnitude data GM and the phase data Gx, Gy, and Gz are volume data acquired at a predetermined period along a time axis t.

The phase data Gx, Gy, and Gz are obtained by encoding (velocity encoding (VENC)) a measurement result obtained by the PC-MRI in the X-axis direction, the Y-axis direction, and the Z-axis direction, respectively. The phase data Gx, Gy, and Gz are data representing the blood flow velocity (flow velocity) in each axial direction, and a three-dimensional flow velocity vector of each voxel can be obtained from the three phase data.

As the period of the acquisition of the volume data, for example, a period set within an average heart rate interval is employed. Since the blood flow shows a periodic variation in synchronization with the heart rate, a data acquisition timing is determined based on the heart rate interval, so that the data indicating the periodic variation in the blood flow can be acquired.

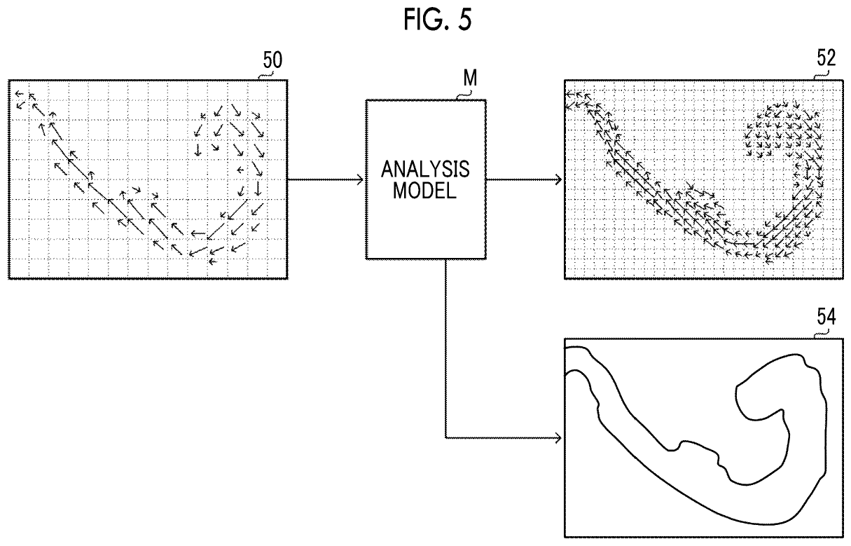

The generation unit 32 uses the analysis model M to generate a flow velocity estimation image having a higher resolution than the flow velocity image and a morphological image representing a morphology of the structure from the flow velocity image. As shown in FIG. 5, the analysis model M is a learning model for generating the flow velocity estimation image and the morphological image from the flow velocity image. The high resolution means that a spatial resolution is high. That is, the flow velocity estimation image includes a three-dimensional flow velocity vector having a higher spatial resolution than the three-dimensional flow velocity vector included in the flow velocity image.

It should be noted that, in FIG. 5, for ease of understanding, the flow velocity image is shown as a flow velocity visualization image 50 in which the spatial distribution of the flow velocity vector included in the flow velocity image is visualized. Similarly, the flow velocity estimation image is shown as a flow velocity visualization image 52 in which the spatial distribution of the flow velocity vector included in the flow velocity estimation image is visualized. In the flow velocity visualization images 50 and 52, a direction of the flow velocity vector is indicated by an inclination of an arrow and an arrowhead, and a velocity of the flow velocity vector is indicated by a length of the arrow. In the flow velocity visualization images 50 and 52, the spatial resolution is indicated by a dotted line grid.

The analysis model M is trained based on a loss function L using at least the information on the physical law of the fluid and the flow velocity image. The information on the physical law of the fluid is, for example, a differential equation as a governing equation describing the motion of the fluid. Specifically, the analysis model M is a model called physics-informed neural networks (PINNs) in which a solution of a governing equation of a certain physical phenomenon is configured by a neural network (hereinafter, referred to as NN).

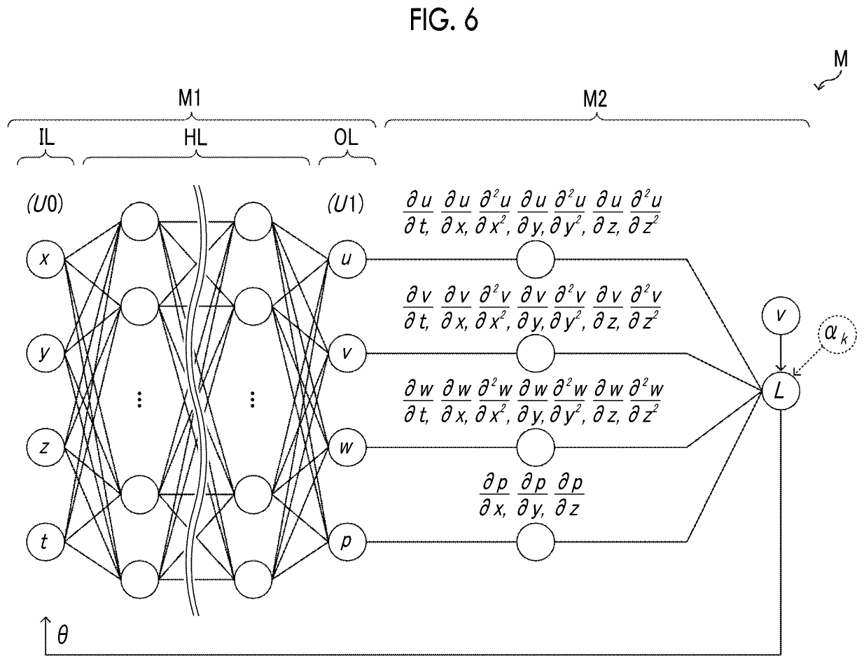

FIG. 6 shows an example of a detailed configuration of the analysis model M (PINNs). The analysis model M includes a first half portion M1 composed of the NN that obtains the solution of the governing equation based on the input (flow velocity image) and a parameter θ, and a second half portion M2 that performs calculation for optimizing the parameter θ based on the loss function L. The analysis model M is an example of a learning model of the present disclosure.

Hereinafter, an example will be described in which Navier-Stokes equations (hereinafter, referred to as an NS equation) of a non-compressible fluid having a constant viscosity are applied to the analysis model M. The NS equation is an example of a differential equation as the governing equation describing the motion of the blood flow, and is represented by Equation (1).

$$\frac{\partial U}{\partial t} + ( U \cdot ∇ ) U = - ∇ p + v Δ U \qquad ( 1 )$$

Here, U is a flow velocity and is a function of three-dimensional space coordinates (x, y, z) and a time (t). Here, p is a pressure and is a function of three-dimensional space coordinates (x, y, z) and a time (t). Here, ν is a dynamic viscosity coefficient of the fluid (here, the blood) and is a constant.

It should be noted that, in a case in which the NS equation is expressed for each of the X-axis direction, the Y-axis direction, and the Z-axis direction without using the Nabla operator and the Laplacian, Equations (1x), (1y), and (1z) are obtained.

$$\frac{\partial u}{\partial t} + u \frac{\partial u}{\partial x} + v \frac{\partial u}{\partial y} + w \frac{\partial u}{\partial z} = - \frac{\partial p}{\partial x} + v ( \frac{{\partial }^{2} u}{\partial {x}^{2}} + \frac{{\partial }^{2} u}{\partial {y}^{2}} + \frac{{\partial }^{2} u}{\partial {z}^{2}} ) \qquad ( 1 x )$$

$$\frac{\partial v}{\partial t} + u \frac{\partial v}{\partial x} + v \frac{\partial v}{\partial y} + w \frac{\partial v}{\partial z} = - \frac{\partial p}{\partial y} + v ( \frac{{\partial }^{2} v}{\partial {x}^{2}} + \frac{{\partial }^{2} v}{\partial {y}^{2}} + \frac{{\partial }^{2} v}{\partial {z}^{2}} ) \qquad ( 1 y )$$

$$\frac{\partial w}{\partial t} + u \frac{\partial w}{\partial x} + v \frac{\partial w}{\partial y} + w \frac{\partial w}{\partial z} = - \frac{\partial p}{\partial z} + v ( \frac{{\partial }^{2} w}{\partial {x}^{2}} + \frac{{\partial }^{2} w}{\partial {y}^{2}} + \frac{{\partial }^{2} w}{\partial {z}^{2}} ) \qquad ( 1 z )$$

Here, u is a component of the flow velocity in the X-axis direction, and is a function of three-dimensional space coordinates (x, y, z) and a time (t). Here, ν is a component of the flow velocity in the Y-axis direction, and is a function of three-dimensional space coordinates (x, y, z) and a time (t). Here, w is a component of the flow velocity in the Z-axis direction, and is a function of three-dimensional space coordinates (x, y, z) and a time (t).

As shown in FIG. 6, the first half portion M1 of the analysis model M is an NN including an input layer IL, a hidden layer (intermediate layer) HL, and an output layer OL. The input of the NN is each variable (x, y, z, t) of the flow velocity U. The outputs of the NN are the components u (x, y, z, t), v (x, y, z, t), w (x, y, z, t) of the flow velocity in each axial direction, and the pressure p (x, y, z, t). The NN approximates the solution of the governing equation based on the input by using the universal approximation theorem of the NN. It should be noted that, as the NN, for example, various models such as a convolutional neural network (CNN) and a recurrent neural network (recurrent NN) can be applied as appropriate.

The parameter θ used for generating the solution in the first half portion M1 (NN) of the analysis model M is optimized based on the loss function L derived in the second half portion M2 of the analysis model M. An example of the loss function L in a case in which Equation (1) is applied as the governing equation is shown in Equations (2) to (4).

$$L = L 1 + L 2 \qquad ( 2 )$$

$$L 1 = \sqrt{\frac{1}{N 1} {\sum }_{i = 1}^{N 1} {( U 0 ( {x}_{i} , {y}_{i} , {z}_{i} , {t}_{i} ) - U 1 ( {x}_{i} , {y}_{i} , {z}_{i} , {t}_{i} ) )}^{2}} \qquad ( 3 )$$

$$L 2 = \sqrt{\frac{1}{N 2} {\sum }_{j = 1}^{N 2} {( \frac{\partial U 1}{\partial t} + ( U 1 \cdot ∇ ) U 1 + ∇ p - v Δ U 1 )}^{2}} \qquad ( 4 )$$

Here, U0 is an actually measured value of the flow velocity U (the flow velocity derived based on the PC-MRI image G0). Here, U1 is a predicted value of the flow velocity U derived based on the output of the first half portion M1 (NN). Specifically, the predicted value U1 (xᵢ, yᵢ, zᵢ, tᵢ) is derived from u (xᵢ, yᵢ, zᵢ, tᵢ), v (xᵢ, yᵢ, zᵢ, tᵢ), w (xᵢ, yᵢ, zᵢ, tᵢ), and p (xᵢ, yᵢ, zᵢ, tᵢ) that are outputs in a case in which the actually measured value U0 (xᵢ, yᵢ, zᵢ, tᵢ) is input to the NN. Here, i is an integer of 1 to N1, and N1 is the number of data of the actually measured value U0 of the flow velocity. Here, j is an integer of 1 to N2, and N2 is the number of data of the predicted value U1 of the flow velocity.

Here, L1 is a first loss function that represents an error between the actually measured value U0 of the flow velocity and the predicted value U1 of the flow velocity. That is, the first loss function L1 can be said to represent an error between the flow velocity image (actually measured value U0 of the flow velocity) and the flow velocity estimation image (predicted value U1 of the flow velocity). It should be noted that, in Equation (3), the root mean squared error (RMSE) is used, but the present disclosure is not limited to this, and an equation representing an error between two numerical values may be applied as appropriate. Examples of such a equation include a sum of squared error (SSE), a root sum squares (RSS), a mean squared error (MSE), and a mean absolute error (MAE).

Here, L2 is a second loss function that represents a goodness of fit of the predicted value U1 of the flow velocity to the NS equation.

That is, the second loss function L2 can be said to represent a goodness of fit of the flow velocity estimation image (the predicted value U1 of the flow velocity) to the governing equation describing the motion of the fluid. It should be noted that the value of the dynamic viscosity coefficient ν used in the calculation of the second loss function L2 is given to the analysis model M as a parameter, but a literature value or the like may be set as appropriate, or a value estimated in a training phase of the analysis model M may be used (details will be described later).

As shown in FIG. 6, in the second half portion M2 of the analysis model M, the differential calculation is performed for each of the outputs u, v, w, and p of the first half portion M1 of the analysis model M. Here, since the NN defines a function via an algorithm, the NN has a property of easily obtaining the analytical derivative of the output with respect to the input (so-called automatic differentiation). By using this property, in the second half portion M2 of the analysis model M, each of the outputs u, v, w, and p of the first half portion M1 (NN) of the analysis model M can be easily and accurately differentiated. Therefore, the second loss function L2 can be easily and accurately calculated in the analysis model M.

With the analysis model M, the outputs u(x, y, z, t), v(x, y, z, t), w(x, y, z, t), and p(x, y, z, t) are obtained for any value of independent variables (x, y, z, t). The generation unit 32 sets Δx, Δy, Δz, and Δt having spatial and temporal resolutions higher than the input flow velocity image, and obtains the following u, v, w, and p with respect to a certain reference point x0, y0, z0, and t0 by using the analysis model M, to generate the flow velocity estimation image having a higher resolution than an original flow velocity image.

$$u ( x 0 + i \times Δ x , y 0 + j \times Δ y , z 0 + k \times Δ z , t 0 + 1 \times Δ t )$$

$$v ( x 0 + i \times Δ x , y 0 + j \times Δ y , z 0 + k \times Δ z , t 0 + 1 \times Δ t )$$

$$w ( x 0 + i \times Δ x , y 0 + j \times Δ y , z 0 + k \times Δ z , t 0 + 1 \times Δ t )$$

$$p ( x 0 + i \times Δ x , y 0 + j \times Δ y , z 0 + k \times Δ z , t 0 + 1 \times Δ t )$$

Here, i, j, k, and l are integers.

Further, the generation unit 32 generates the morphological image 54. For example, the generation unit 32 may generate a morphological image indicating a contour by extracting the contour of a region in which the predicted value U1 of the flow velocity is 0 in the flow velocity estimation image. This configuration utilizes that the flow velocity is 0 in a vascular wall.

In addition, for example, the generation unit 32 may use a morphological image generation model for generating the morphological image 54 from at least one of the flow velocity image or the flow velocity estimation image, to generate the morphological image 54 from at least one of the flow velocity image or the flow velocity estimation image. The morphological image generation model is, for example, an NN that has been trained in advance using a combination of at least one of the flow velocity image or the flow velocity estimation image and the morphological image, as training data.

In a case in which the morphological image generation model is used, the morphological image generation model is incorporated into the analysis model M constructed by the above-described PINNs. That is, the analysis model M may include a PINNs model for generating the flow velocity estimation image from the flow velocity image, and the morphological image generation model for generating the morphological image 54 from at least one of the flow velocity image or the flow velocity estimation image. The PINNs model referred to here is an example of a first learning model of the present disclosure, and the morphological image generation model is an example of a second learning model of the present disclosure.

In addition, the generation unit 32 may use the analysis model M to further generate a pressure image representing a distribution of the pressure of the fluid in the structure from the flow velocity image. As described above, with the analysis model M, the distribution of the pressure p(x, y, z, t) can be obtained with high spatial and temporal resolution, so that the pressure image can be generated.

In addition, the generation unit 32 may generate the flow velocity visualization image 50 in which the flow velocity vector included in the flow velocity image is visualized, from the flow velocity image. Similarly, the generation unit 32 may generate the flow velocity visualization image 52 in which the flow velocity vector included in the flow velocity estimation image is visualized, from the flow velocity estimation image (see FIG. 5).

It should be noted that the means for visualizing the flow velocity vector is not limited to the example of FIG. 5, and, for example, the velocity of the flow velocity vector may be indicated by a thickness, a line type (a solid line, a dotted line, a two-point dashed line, or the like), a color, or transparency of an arrow. In addition, for example, a mark having a polygonal shape such as a triangular shape may be used instead of the arrow, or a mark in which a round mark or the like is attached to one end of a straight line may be used. In addition, in FIG. 5, the two-dimensional flow velocity visualization images 50 and 52 are obtained by projecting the three-dimensional flow velocity vectors in the flow velocity image and the flow velocity estimation image onto a certain two-dimensional plane, but the present disclosure is not limited to this, and a three-dimensional flow velocity visualization image may be used.

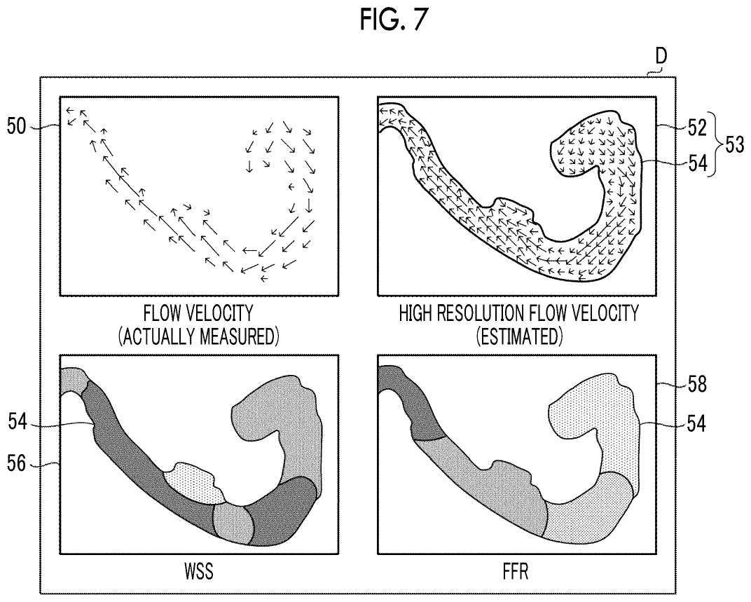

The derivation unit 34 may derive various indicators for using the flow of the fluid for the diagnosis and the treatment based on at least one of the flow velocity image, the flow velocity estimation image, the morphological image, the pressure image, or the flow velocity visualization image. In addition, the derivation unit 34 may generate an image (hereinafter, referred to as an indicator visualization image) in which the magnitude of the derived indicator is visualized. Examples of the indicator visualization image include a heat map in which regions in the morphological image are color-coded in accordance with the magnitude of the indicator for each region (see FIG. 7).

For example, the derivation unit 34 may derive a wall shear stress (WSS) for each region in the morphological image, based on the flow velocity estimation image and the morphological image. The WSS indicates a frictional stimulus of the blood flow applied to the vascular wall. By quantifying the WSS, it may be possible to analyze the occurrence and progression (rupture) of vascular diseases, such as atherosclerosis and aneurysm. The atherosclerosis occurs most commonly in the coronary artery, the abdominal aorta, and the carotid artery, and contributes to vascular stenosis. The aneurysm may occur in the cerebral artery, the abdominal aorta, the thoracic aorta, and the like.

The WSS can be quantified by a velocity gradient in the Y-axis direction of the component u of the flow velocity U in the X-axis direction in a case in which a direction parallel to the vascular wall is defined as the X-axis direction and a direction perpendicular to the vascular wall is defined as the Y-axis direction. In a case in which an amount of the WSS in this case is denoted by r, T is represented by Equation (5).

$$τ = μ \frac{\partial u}{\partial y} {\vert}_{{y}_{w}} \qquad ( 5 )$$

Here, y_{w} is a position of the vascular wall in the y-axis direction, and can be specified from the morphological image. Here, μ is a viscosity coefficient of the fluid (here, the blood). It should be noted that, in a case in which the dynamic viscosity coefficient of the fluid is denoted by ν and the density of the fluid is denoted by ρ, a relationship of μ=ρν holds true. Therefore, μ is obtained from the value of ν used in the analysis model M and the literature value of ρ (for example, 1.056 kg/m³). The derivation unit 34 derives an amount τ of the WSS at any position (y_{w}) on the vascular wall by specifying each numerical value to be substituted in Equation (5) from the flow velocity estimation image and the morphological image.

In addition, the derivation unit 34 may generate the indicator visualization image in which the magnitude of the WSS for each region in the morphological image is visualized. For example, the derivation unit 34 may generate a heat map color-coded in accordance with the magnitude of the WSS (see FIG. 7).

In addition, for example, the derivation unit 34 may derive fractional flow reserve (FFR) for each region in the morphological image based on the pressure image and the morphological image. The FFR is an indicator of the severity of a stenotic lesion of the coronary artery, and is used as a guideline for performing the coronary revascularization. The FFR can be quantified by a ratio of a blood pressure before and after a stenotic part. For example, in a case in which the blood pressure before the stenotic part is denoted by Pa and the blood pressure after the stenotic part is denoted by Pd, the FFR is represented by Equation (6).

$$FFR = Pd / Pa \qquad ( 6 )$$

In addition, the derivation unit 34 may generate an indicator visualization image in which the magnitude of the FFR for each region in the morphological image is visualized. For example, the derivation unit 34 may generate a heat map in which the FFR is color-coded in accordance with the magnitude of the FFR (see FIG. 7). Specifically, for example, any point before the stenotic part may be used as a virtual reference point, and the blood pressure at the reference point may be denoted by Pa, and the ratio of the blood pressure to the blood pressure Pa may be derived for each region in the blood vessel.

The display controller 36 performs control of displaying, on the display 24, at least one of the flow velocity image, the flow velocity estimation image, the morphological image, the pressure image, the flow velocity visualization image, or the indicator visualization image. FIG. 7 shows an example of a screen D displayed on the display 24 by the display controller 36. As an example, the screen D includes the flow velocity visualization image 50 of the flow velocity image. In addition, the screen D includes a composite image 53 in which the flow velocity visualization image 52 and the morphological image 54 of the flow velocity estimation image are superimposed so as to spatially and temporally match.

In addition, the screen D includes a WSS indicator visualization image 56 for each region in the morphological image 54. In addition, the screen D includes an FFR indicator visualization image 58 for each region in the morphological image 54. The indicator visualization images 56 and 58 are heat maps in which the regions of the blood vessels included in the morphological image 54 are color-coded in accordance with the magnitude of the WSS and the magnitude of the FFR, respectively.

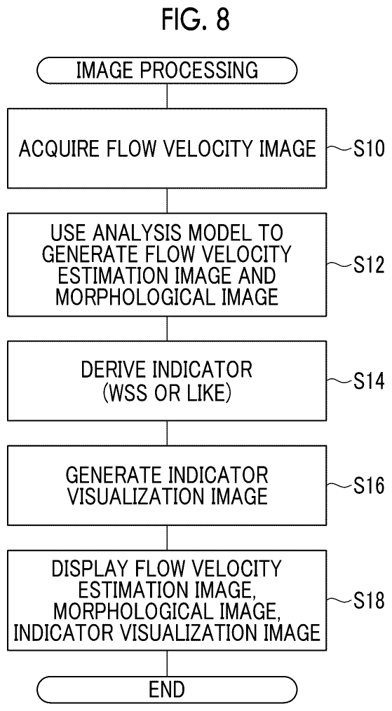

Hereinafter, an operation of the image processing device 10 will be described with reference to FIG. 8. In the image processing device 10, the CPU 21 executes the image processing program 27 to execute image processing shown in FIG. 8. The present processing is executed, for example, in a case in which a user issues an instruction to start the execution via the input unit 25.

In step S10, the acquisition unit 30 acquires the flow velocity image. In step S12, the generation unit 32 uses the analysis model M to generate the flow velocity estimation image and the morphological image from the flow velocity image acquired in step S12. In step S14, the derivation unit 34 derives various indicators such as the WSS and the FFR for each region in the morphological image based on the flow velocity estimation image and the morphological image generated in step S12. In step S16, the derivation unit 34 generates the indicator visualization image in which the magnitude of the indicator derived in step S14 is visualized for each region in the morphological image generated in step S12.

In step S18, the display controller 36 performs control of controlling, on the display 24, at least one of the flow velocity estimation image generated in step S12, the morphological image generated in step S12, or the indicator visualization image generated in step S16. It should be noted that, as shown in FIG. 7, the display controller 36 may display the flow velocity estimation image as the flow velocity visualization image 52, or may display the flow velocity estimation image (or the flow velocity visualization image 52) and the morphological image 54 in a superimposed manner. In a case in which step S18 is completed, the present processing is ended.

As described above, the image processing device 10 according to the present embodiment comprises at least one processor, in which the processor is configured to: use a learning model that is a learning model for generating, from a flow velocity image representing a spatial distribution of a flow velocity vector of fluid in a structure of a living body, a flow velocity estimation image having a higher resolution than the flow velocity image and a morphological image representing a morphology of the structure and that is trained based on a loss function using at least information on a physical law of the fluid and the flow velocity image, to generate the flow velocity estimation image and the morphological image from the flow velocity image.

With the image processing device 10, the analysis model M (PINNs) trained based on the loss function L using the information on the physical law of the fluid is used, so that a high-resolution flow velocity estimation image and a high-resolution morphological image can be generated based on a low-resolution flow velocity image. That is, it is possible to specify a more spatially fine velocity vector and the morphology of the structure even from the low-resolution flow velocity image. Therefore, it is possible to analyze the flow of the fluid in the structure of the living body with high accuracy, and it is possible to contribute to the improvement of the quantification accuracy of the indicators such as the WSS and the FFR.

### Comparative Example

As a method of blood flow analysis used in the related art, there is a method of capturing a morphological image by, for example, magnetic resonance angiography (MRA) in addition to a flow velocity image obtained by PC-MRI. This is because the flow velocity vector is discrete in the PC-MRI image and there is a resolution constraint, and the purpose is to specify a structure of a thin blood vessel (for example, a cerebral artery and a coronary artery) based on the MRA image. In this method, the registration between the PC-MRI image and the MRA image is required in order to spatially match the blood flow and the structure of the blood vessel.

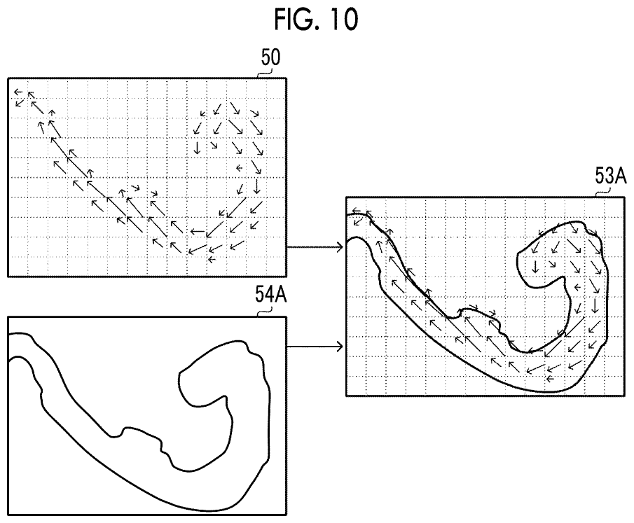

FIG. 10 shows an example of the flow velocity visualization image 50 of the flow velocity image (PC-MRI image), a morphological image 54A obtained by the MRA, and a composite image 53A of the flow velocity visualization image 50 and the morphological image 54A. As shown in FIG. 10, in the related-art method of performing the registration between separately captured images, the spatial misregistration may occur. In particular, in the derivation of the WSS (see Equation (5)), the specification of the flow velocity vector in the vicinity of the position (y_{w}) of the vascular wall is important, so that the quantification accuracy of the WSS may be reduced due to the misregistration.

As compared with the related-art method, in the image processing device 10 according to the present embodiment, since the flow velocity estimation image and the morphological image are flow velocity images having the same generation source, the registration between the flow velocity estimation image (or the flow velocity image) and the morphological image is not necessary. Therefore, it is possible to avoid the decrease in the accuracy of the analysis result due to the misregistration. In addition, since the capturing of the morphological image is not necessary, the time and cost can be reduced.

### First Modification Example

In the above-described embodiment, the example has been described in which the sum (see Equation (2)) of the first loss function L1 and the second loss function L2 is applied as the loss function L used in the analysis model M, but the present disclosure is not limited to this. In the training phase of the learning model, the search for the parameter θ that minimizes the loss function L is repeatedly performed, but the loss function L may be changed in accordance with the number of iterations in the training of the analysis model M.

Specifically, the analysis model M may be trained using a weighted sum of the first loss function L1 and the second loss function L2. For example, a weighted sum of Equation (2-1) instead of Equation (2) may be applied.

$$L = k 1 \times L 1 + k 2 \times L 2 \qquad ( 2 - 1 )$$

Here, k1 and k2 are weights of the first loss function L1 and the second loss function L2 in the weighted sum, respectively, and are changed in accordance with the number of iterations in the training of the analysis model M. Away of changing the weights k1 and k2 is not particularly limited, but it is desirable that at least one of the weight k1 of the first loss function L1 or the weight k2 of the second loss function L2 is changed so that an influence of the second loss function L2 is increased as the number of iterations is increased.

For example, the weight k2 may be gradually increased and/or the weight k1 may be gradually decreased in accordance with the number of iterations. In addition, for example, at a stage in which the number of iterations exceeds a predetermined threshold value, the weight k1 may be changed from 1 to 0 and the weight k2 may be changed from 0 to 1 (that is, the contents of L may be completely switched from L1 to L2).

In an initial stage in which the training has not progressed, since an optimal solution of the parameter θ is unknown, the parameter θ is generally given randomly based on an appropriate algorithm. In this state, in a case in which the training based on the second loss function L2 derived from the differential equation is performed, an expected optimal solution may not be obtained. For example, as in a trivial solution (U1 is 0) in the differential equation of Equation (4), the second loss function L2 is minimized, but the parameter θ that does not consider the minimization of the first loss function L1 may be set as the optimal solution (so-called local minimum solution).

Therefore, by giving priority to the first loss function L1 while the number of iterations is small and giving priority to the second loss function L2 as the number of iterations is increased, it is possible to avoid the solution from falling into a local minimum solution. As described above, by changing the contents of the loss function L in accordance with the number of iterations in the training, it may be possible to efficiently advance the training.

### Second Modification Example

In the above-described embodiment, the example has been described in which the morphological image is generated by extracting the contour of the region in which the flow velocity is 0 in the flow velocity estimation image or generated by the morphological image generation model, but the present disclosure is not limited to this. For example, in the training phase of the analysis model M, the position of the vascular wall may be estimated by performing training based on the loss function L including a term that considers a condition on the vascular wall as a boundary condition in the governing equation.

Specifically, the analysis model M may be trained based on the first loss function L1, the second loss function L2, and a third loss function L3 representing a goodness of fit to the boundary condition in the governing equation. For example, Equation (2-2) may be applied instead of Equation (2). An example of the third loss function L3 is shown in Equation (7).

$$L = L 1 + L 2 + L 3 \qquad ( 2 - 2 )$$

$$L 3 = \sqrt{\frac{1}{N 3} {\sum }_{k = 1}^{N 3} {( U 1 ( {x}_{k} , {y}_{k} , {z}_{k} ) - 0 )}^{2}} \qquad ( 7 )$$

Here, U1 is a predicted value of the flow velocity U that is derived based on the output of the first half portion M1 (NN) of the analysis model M. It is considered to represent the vascular wall with three-dimensional polygonal data, and coordinates of the vertices are denoted by αₖ(xₖ, yₖ, zₖ). Here, k is an integer of 1 to N3, and N3 is the number of data of coordinates of the vertices of the vascular wall. As shown by a dotted line in FIG. 6, the coordinates αₖ are given to the analysis model M as the parameter used to calculate the loss function L.

Equation (7) uses a boundary condition in which the predicted value U1 of the flow velocity is 0 at the coordinates αₖ (xₖ, yₖ, zₖ) on the vascular wall. That is, the third loss function L3 can be said to represent the goodness of fit of the flow velocity estimation image (that is, the predicted value U1 of the flow velocity) corresponding to the wall position of the structure represented by the morphological image, to the boundary condition in the governing equation describing the motion of the fluid.

In the training phase of the analysis model M, appropriate coordinates αₖ can be estimated by performing the training so that the third loss function L3 is minimized while changing the coordinates αₖ (xₖ, yₖ, zₖ). As a result, the coordinates αₖ of the vertices constituting the vascular wall, that is, the position of the vascular wall is obtained, and thus the morphological image representing the position of the vascular wall can be generated.

### Third Modification Example

The method of the first modification example may be applied to the second modification example. Specifically, the analysis model M may be trained using a weighted sum of the first loss function L1, the second loss function L2, and the third loss function L3. For example, a weighted sum of Equation (2-3) instead of Equation (2-2) may be applied.

$$L = k 1 \times L 1 + k 2 \times L 2 + k 3 \times L 3 \qquad ( 2 - 3 )$$

Here, k1 to k3 are the weights of the first loss function L1, the second loss function L2, and the third loss function L3 in the weighted sum, respectively, and are changed in accordance with the number of iterations in the training of the analysis model M. A way of changing the weights k1 to k3 is not particularly limited, but it is desirable that at least one of the weight k1 of the first loss function L1, the weight k2 of the second loss function L2, or the weight k3 of the third loss function L3 is changed so that an influence of at least one of the second loss function L2 or the third loss function L3 is increased as the number of iterations is increased. The reason is the same as that in the first modification example.

For example, the weights k2 and k3 may be gradually increased and/or the weight k1 may be gradually decreased in accordance with the number of iterations. In addition, for example, at a stage in which the number of iterations exceeds a predetermined threshold value, the weight k1 may be changed from 1 to 0, the weight k2 may be changed from 0 to 1, and the weight k3 may be changed from 0 to 1 (that is, the contents of L may be switched from the single L1 to the sum of L2 and L3).

### Fourth Modification Example

Similar to the coordinates αₖ of the second modification example, other parameters used to calculate the loss function L may be estimated in the training phase of the analysis model M. For example, in the second loss function L2 of Equation (2), the appropriate dynamic viscosity coefficient ν can be estimated by performing the training so that the second loss function L2 is minimized while changing the dynamic viscosity coefficient ν.

In such a case, a more appropriate dynamic viscosity coefficient ν can be estimated in the fluid to be analyzed, and thus, for example, individual differences in the dynamic viscosity coefficient ν can be taken into consideration, and the blood flow can be analyzed with higher accuracy.

In particular, since the dynamic viscosity coefficient ν also affects the viscosity coefficient μ (μ=ρν) used to quantify the WSS, the quantification accuracy of the WSS can also be improved.

### Fifth Modification Example

In the above-described embodiment, the example has been described in which the NS equation is applied as the governing equation used in the analysis model M (PINNs), but the present disclosure is not limited to this. Another governing equation describing the motion of the fluid may be applied in addition to or instead of the NS equation.

For example, in a case in which a circuit equation in a case in which a Windkessel model is used is applied as the governing equation of the analysis model M, an outflow boundary condition can be analyzed. The Windkessel model describes the blood flow with an electric circuit model by describing the influence of the erased blood vessel (for example, difficulty in blood flow) on the analysis region with the characteristic value of the circuit element. In general, since it is difficult to measure the blood pressure, the resistance, and the like in the peripheral blood vessel, it is also difficult to specify the outflow boundary condition in the analysis region, but the outflow boundary condition can be estimated by using the Windkessel model.

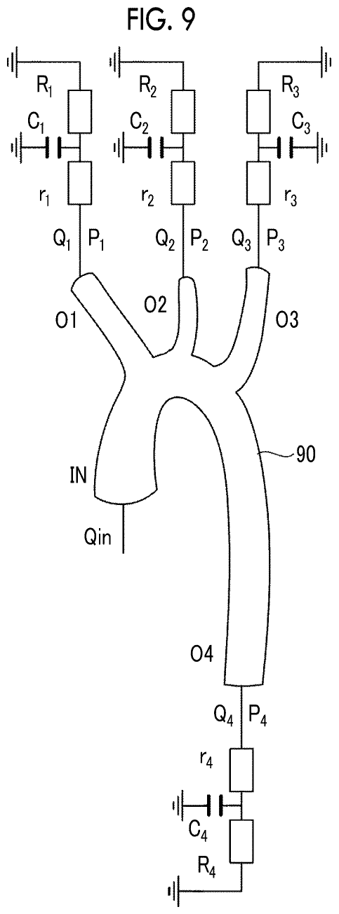

FIG. 9 shows an example in which a 3-element Windkessel model is applied to a 4-branch blood vessel 90. In FIG. 9, an inflow port IN and four outflow ports O1 to O4 are shown for the 4-branch blood vessel 90, and the 3-element Windkessel model is connected to each of the outflow ports O1 to O4. In the 3-element Windkessel model, a blood flow rate Q is described as a current, the blood pressure P is described as a voltage, an arterial compliance C is described as a capacitance of a capacitor, a peripheral vascular resistance R is described as a resistance of a resistor, and a resistance r due to the aortic valve is described as a characteristic impedance. The circuit equation in this case is shown in Equation (8).

$$Q + C ( \frac{d ( Qr - P )}{dt} ) + \frac{QR - P}{R} = 0 \qquad ( 8 )$$

By incorporating such a Windkessel model into the analysis model M, the characteristic values R, C, and r can be estimated at each of outflow boundaries. Hereinafter, the blood flow rate at the outflow boundary Ok is referred to as Qₖ, the blood pressure is referred to as Pₖ, and the characteristic values are referred to as Rₖ, Cₖ, and rₖ. Here, k is an integer of 1 to N4, and N4 is the number of outflow boundaries. It should be noted that, in FIG. 9, the notation is also made in accordance with this method.

Specifically, the blood flow rate Qₖ and the blood pressure Pₖ at each outflow boundary Ok need only be added to the output layer OL of the first half portion M1 of the analysis model M. In addition, as the parameters used to calculate the loss function L, the characteristic values Rₖ, Cₖ, and rₖ at each outflow boundary Ok need only be added. In addition, the fourth loss function L4 represented by Equation (9) need only be added to the loss function L of the analysis model M.

$$L 4 = \sqrt{\frac{1}{N 4} {\sum }_{k = 1}^{N 4} {( {Q}_{k} + {C}_{k} ( \frac{d ( {Q}_{k} {r}_{k} - {P}_{k} )}{dt} ) + \frac{{Q}_{k} {R}_{k} - {P}_{k}}{{R}_{k}} )}^{2}} \qquad ( 9 )$$

The fourth loss function L4 represents a goodness of fit of the predicted values of the blood flow rate Qₖ and the blood pressure Pₖ at each outflow boundary Ok to the circuit equation. In the fourth loss function L4, the characteristic values Rₖ, Cₖ, and rₖ can be estimated by performing the training so that the fourth loss function L4 is minimized while changing the characteristic values Rₖ, Cₖ, and rₖ.

With the analysis model M trained in this way, the predicted values of the blood flow rate Qₖ and the blood pressure Pₖ at each outflow boundary Ok can be obtained, so that the outflow boundary condition can be estimated. Therefore, the flow of the fluid in the structure of the living body can be analyzed with high accuracy.

It should be noted that the estimated outflow boundary condition can also be used for simulation by blood flow analysis (computational fluid dynamics (CFD)) using numerical fluid dynamics. In the CFD, the accuracy of the blood flow analysis can be improved by setting a high-accuracy outflow boundary condition estimated by the above-described method. As a result, for example, it is possible to simulate the change in the blood flow in a case in which the vascular structure is changed due to a surgical operation such as stenosis dilation and aneurysm embolization with high accuracy, and thus it is expected that the simulation result can be used for examining the treatment effect.

### Sixth Modification Example

Further, for example, a lattice Boltzmann equation may be applied as the governing equation of the analysis model M. The fluid can be described by translational movement and collision of individual particles on a microscopic scale. The lattice Boltzmann equation is a fluid analysis model in which a space is discretized in a lattice form and a velocity of a particle is discretized in a finite type of the velocity vector based on this viewpoint. According to the lattice Boltzmann equation, the flow of the fluid is analyzed by a temporal change in the distribution function of the particles in each lattice.

The lattice Boltzmann equation in a model (two-dimensional 9-velocity model) in which the velocity vector is discretized into nine states in a two-dimensional space (XY space) is shown in Equation (10). In the two-dimensional 9-velocity model, in a certain lattice having four points of coordinates (x, y)=(±1, ±1) as vertices, the start points of the discretized nine velocity vectors are set to (0, 0), and the end points thereof are set to (0, 0), (±1, 0), (0, ±1), and (±1, ±1), respectively. The magnitude of each velocity vector is a constant.

$$\frac{\partial {F}_{i}}{\partial t} + {c}_{i} ∇ {F}_{i} = \frac{1}{τ} ( {F}_{i}^{eq} - {F}_{i} ) \qquad ( 10 )$$

Here, cᵢ is a discretized velocity vector, and i is an integer of 0 to 8. That is, co to cs correspond to the nine velocity vectors. Here, Fᵢ is a distribution function of particles corresponding to the velocity vector cᵢ at the time t and at a lattice point. It should be noted that the distribution function Fᵢ is a discrete distribution function since a random variable is discrete. Fᵢ^{eq} is an equilibrium distribution function. Here, T is a relaxation parameter.

In a case in which the analysis model M (PINNs) is used, the lattice Boltzmann equation can be solved, and thus the flow of the fluid can be analyzed. Specifically, the distribution function Fᵢ need only be added to the output layer OL of the first half portion M1 of the analysis model M. In addition, the equilibrium distribution function Fᵢ^{eq} and the relaxation parameter T need only be added as the parameters used to calculate the loss function L. The fifth loss function L5 represented by Equation (11) need only be added to the loss function L of the analysis model M.

$$L 5 = \sqrt{\frac{1}{N 5} {\sum }_{k = 1}^{N 5} {( \frac{\partial {F}_{ik}}{\partial t} + {c}_{ik} ∇ {F}_{ik} - \frac{1}{τ} ( {F}_{ik}^{eq} - {F}_{ik} ) )}^{2}} \qquad ( 11 )$$

Here, k is an integer of 1 to N5, and N5 is the number of data of the predicted value of the distribution function Fᵢ. The fifth loss function L5 represents a goodness of fit of the predicted value of the distribution function Fᵢ to the lattice Boltzmann equation. In the fifth loss function L5, the equilibrium distribution function Fᵢ^{eq} and the relaxation parameter T can be estimated by performing the training so that the fifth loss function L5 is minimized while changing the equilibrium distribution function Fᵢ^{eq} and the relaxation parameter T.

With the analysis model M trained in this way, it is possible to obtain the predicted value of the distribution function Fᵢ at each time point t and at each lattice point. Therefore, the flow of the fluid in the structure of the living body can be analyzed with high accuracy.

It should be noted that the loss function L described in the embodiment and each modification example described above may be a sum including any combination of the first loss function L1 to the fifth loss function L5. In addition, the weighted sum in which the weights are set for each of the first loss function L1 to the fifth loss function L5 included in the loss function L may be used. In this case, each weight may be changed in accordance with the number of iterations of the training.

In addition, in the above-described embodiment, the example has been described in which the analysis model M, which has been trained, is stored in the storage unit 22 in advance, but the present disclosure is not limited to this. For example, the image processing device 10 may have a function of training the analysis model M. Specifically, the CPU 21 may construct the analysis model M by performing training using the loss function L including at least one of the first loss function L1, the second loss function L2, the third loss function L3, the fourth loss function L4, or the fifth loss function L5. In addition, for example, the CPU 21 may perform re-training of the analysis model M based on the flow velocity image, the flow velocity estimation image, and the morphological image each time the generation unit 32 generates the flow velocity estimation image and the morphological image from the flow velocity image.

In addition, in the above-described embodiment, the example has been described in which the flow velocity image is acquired by the PC-MRI, but the present disclosure is not limited to this. For example, an ultrasound device may be used as the imaging device 3 to acquire a three-dimensional ultrasound image captured in time series via Doppler measurement, and the flow velocity image may be acquired based on the ultrasound image.

In addition, in the above-described embodiment, the WSS and the FFR have been described as various indicators for using the flow of the fluid for the diagnosis and the treatment, but the present disclosure is not limited to this. For example, the vorticity, helicity, and the like may be applied as such an indicator.

In addition, in the above-described embodiment, the example has been described in which the structure is the blood vessel, and the fluid is the blood, but the present disclosure is not limited to this. For example, in a case of considering the analysis of the flow of cerebrospinal fluid, as a structure through which the cerebrospinal fluid flows, a ventricle in an intracranial cavity, particularly a subarachnoid space, or a subarachnoid space of a spinal canal can be applied. For example, a lymphatic vessel may be used as the structure, and a lymphatic fluid may be used as the fluid.

In addition, in the above-described embodiment, the image of the human body is used as the target, but the present disclosure is not limited to this. For example, the present disclosed technology can also be applied in a case of analyzing a flow of fluid that flows in a pipe.

In addition, in the above-described embodiment, for example, as hardware structures of processing units that execute various types of processing, such as the acquisition unit 30, the generation unit 32, the derivation unit 34, and the display controller 36, various processors shown below can be used. As described above, in addition to the CPU that is a general-purpose processor that executes software (program) to function as various processing units, the various processors include a programmable logic device (PLD) that is a processor whose circuit configuration can be changed after manufacture, such as a field programmable gate array (FPGA), and a dedicated electric circuit that is a processor whose circuit configuration is designed for exclusive use in order to execute specific processing, such as an application specific integrated circuit (ASIC).

One processing unit may be configured by one of the various processors or may be configured by a combination of two or more processors of the same type or different types (for example, a combination of a plurality of FPGAs or a combination of a CPU and an FPGA). In addition, a plurality of the processing units may be configured by one processor.

A first example of the configuration in which the plurality of processing units are configured by one processor is a form in which one processor is configured by a combination of one or more CPUs and the software and this processor functions as the plurality of processing units, as represented by computers, such as a client and a server. Second, as represented by a system-on-chip (SoC) or the like, there is a form in which the processor is used in which the functions of the entire system which includes the plurality of processing units are implemented by a single integrated circuit (IC) chip. In this manner, as the hardware structure, the various processing units are configured by using one or more of the various processors described above.

Further, the hardware structure of these various processors is, more specifically, an electric circuit (circuitry) in which the circuit elements, such as semiconductor elements, are combined.

In the above-described embodiment, the aspect has been described in which the image processing program 27 is stored (installed) in the storage unit 22 in advance, but the present disclosure is not limited to this. The program may be provided in a form of being recorded on a recording medium, such as a compact disc read only memory (CD-ROM), a digital versatile disc read only memory (DVD-ROM), or a universal serial bus (USB) memory. In addition, the program may be downloaded from an external device via a network. Further, the present disclosed technology includes, in addition to the program, a storage medium that stores the program in a non-transitory manner.

In the present disclosed technology, the embodiment and the modification examples described above can be combined as appropriate. The above-described contents and the above-shown contents are detailed descriptions of portions related to the present disclosed technology and are merely examples of the present disclosed technology. For example, the above description related to the configuration, the function, the operation, and the effect is the description related to the examples of the configuration, the function, the operation, and the effect of the parts according to the present disclosed technology. As a result, it is needless to say that unnecessary parts may be deleted, new elements may be added, or replacements may be made with respect to the above-described contents and the above-shown contents within a range that does not deviate from the gist of the present disclosed technology.

In regard with the above-described embodiment, the supplementary notes are further disclosed as follows.

### Supplementary Note 1

An image processing device comprising: at least one processor, in which the processor is configured to: use a learning model that is a learning model for generating, from a flow velocity image representing a spatial distribution of a flow velocity vector of fluid in a structure of a living body, a flow velocity estimation image having a higher resolution than the flow velocity image and a morphological image representing a morphology of the structure and that is trained based on a loss function using at least information on a physical law of the fluid and the flow velocity image, to generate the flow velocity estimation image and the morphological image from the flow velocity image.

### Supplementary Note 2

The image processing device according to supplementary note 1, in which the information on the physical law of the fluid is a differential equation as a governing equation describing a motion of the fluid.

### Supplementary Note 3

The image processing device according to supplementary note 2, in which the differential equation is Navier-Stokes equations.

### Supplementary Note 4

The image processing device according to any one of supplementary notes 1 to 3, in which the loss function is changed in accordance with the number of iterations in training of the learning model.

### Supplementary Note 5

The image processing device according to any one of supplementary notes 1 to 4, in which the learning model is trained based on a first loss function representing an error between the flow velocity image and the flow velocity estimation image, and a second loss function representing a goodness of fit of the flow velocity estimation image to a governing equation describing a motion of the fluid.

### Supplementary Note 6

The image processing device according to supplementary note 5, in which the learning model is trained using a weighted sum of the first loss function and the second loss function, and a weight of each of the first loss function and the second loss function in the weighted sum is changed in accordance with the number of iterations in training.

### Supplementary Note 7

The image processing device according to supplementary note 6, in which at least one of the weight of the first loss function or the weight of the second loss function is changed so that an influence of the second loss function is increased as the number of iterations is increased.

### Supplementary Note 8

The image processing device according to supplementary note 5, in which the learning model is trained based on the first loss function, the second loss function, and a third loss function representing a goodness of fit of the flow velocity estimation image, which corresponds to a wall position of the structure represented by the morphological image, to a boundary condition in the governing equation describing the motion of the fluid.

### Supplementary Note 9

The image processing device according to supplementary note 8, in which the learning model is trained using a weighted sum of the first loss function, the second loss function, and the third loss function, and a weight of each of the first loss function, the second loss function, and the third loss function in the weighted sum is changed in accordance with the number of iterations in training.

### Supplementary Note 10

The image processing device according to supplementary note 9, in which at least one of the weight of the first loss function, the weight of the second loss function, or the weight of the third loss function is changed so that an influence of at least one of the second loss function or the third loss function is increased as the number of iterations is increased.

### Supplementary Note 11

The image processing device according to any one of supplementary notes 1 to 10, in which the learning model includes a first learning model that is a first learning model for generating the flow velocity estimation image from the flow velocity image and that is trained based on the loss function using at least the information on the physical law of the fluid and the flow velocity image, and a second learning model for generating the morphological image from at least one of the flow velocity image or the flow velocity estimation image.

### Supplementary Note 12

The image processing device according to supplementary note 1, in which the structure is a blood vessel, and the fluid is blood.

### Supplementary Note 13

The image processing device according to supplementary note 12, in which the blood vessel is at least one of a cerebral artery, a carotid artery, a coronary artery, a thoracic aorta, or an abdominal aorta.

### Supplementary Note 14

The image processing device according to supplementary note 12, in which the flow velocity image is a three-dimensional image acquired by imaging the blood vessel using a three-dimensional cine phase contrast-magnetic resonance imaging method.

### Supplementary Note 15

The image processing device according to supplementary note 12, in which the processor is configured to: derive a wall shear stress for each region in the morphological image based on the flow velocity estimation image and the morphological image.

### Supplementary Note 16

The image processing device according to supplementary note 15, in which the processor is configured to: generate an image in which magnitude of the wall shear stress for each region in the morphological image is visualized.

### Supplementary Note 17

The image processing device according to supplementary note 12, in which the processor is configured to: use the learning model to further generate a pressure image representing a distribution of a pressure of the fluid in the structure from the flow velocity image, and derive fractional flow reserve for each region in the morphological image based on the pressure image and the morphological image.

### Supplementary Note 18

The image processing device according to supplementary note 17, in which the processor is configured to: generate an image in which magnitude of the fractional flow reserve for each region in the morphological image is visualized.

### Supplementary Note 19

An image processing method executed by a computer, the image processing method including: using a learning model that is a learning model for generating, from a flow velocity image representing a spatial distribution of a flow velocity vector of fluid in a structure of a living body, a flow velocity estimation image having a higher resolution than the flow velocity image and a morphological image representing a morphology of the structure and that is trained based on a loss function using at least information on a physical law of the fluid and the flow velocity image, to generate the flow velocity estimation image and the morphological image from the flow velocity image.

### Supplementary Note 20

An image processing program causing a computer to execute a process including: using a learning model that is a learning model for generating, from a flow velocity image representing a spatial distribution of a flow velocity vector of fluid in a structure of a living body, a flow velocity estimation image having a higher resolution than the flow velocity image and a morphological image representing a morphology of the structure and that is trained based on a loss function using at least information on a physical law of the fluid and the flow velocity image, to generate the flow velocity estimation image and the morphological image from the flow velocity image.

What is claimed is:

1. An image processing device comprising a processor, wherein the processor is configured to use a learning model that is a learning model for generating, from a flow velocity image representing a spatial distribution of a flow velocity vector of fluid in a structure of a living body, a flow velocity estimation image having a higher resolution than the flow velocity image and a morphological image representing a morphology of the structure and that is trained based on a loss function using at least information on a physical law of the fluid and the flow velocity image, to generate the flow velocity estimation image and the morphological image from the flow velocity image.

2. The image processing device according to claim 1, wherein the information on the physical law of the fluid is a differential equation as a governing equation describing a motion of the fluid.

3. The image processing device according to claim 2, wherein the differential equation is Navier-Stokes equations.

4. The image processing device according to claim 1, wherein the loss function is changed in accordance with the number of iterations in training of the learning model.

5. The image processing device according to claim 1, wherein the learning model is trained based on:
a first loss function representing an error between the flow velocity image and the flow velocity estimation image; and
a second loss function representing a goodness of fit of the flow velocity estimation image to a governing equation describing a motion of the fluid.

6. The image processing device according to claim 5, wherein:
the learning model is trained using a weighted sum of the first loss function and the second loss function, and
a weight of each of the first loss function and the second loss function in the weighted sum is changed in accordance with the number of iterations in training.

7. The image processing device according to claim 6, wherein at least one of the weight of the first loss function or the weight of the second loss function is changed so that an influence of the second loss function is increased as the number of iterations is increased.

8. The image processing device according to claim 5, wherein the learning model is trained based on:
the first loss function;
the second loss function; and
a third loss function representing a goodness of fit of the flow velocity estimation image, which corresponds to a wall position of the structure represented by the morphological image, to a boundary condition in the governing equation describing the motion of the fluid.

9. The image processing device according to claim 8, wherein:
the learning model is trained using a weighted sum of the first loss function, the second loss function, and the third loss function, and
a weight of each of the first loss function, the second loss function, and the third loss function in the weighted sum is changed in accordance with the number of iterations in training.

10. The image processing device according to claim 9, wherein at least one of the weight of the first loss function, the weight of the second loss function, or the weight of the third loss function is changed so that an influence of at least one of the second loss function or the third loss function is increased as the number of iterations is increased.

11. The image processing device according to claim 1, wherein the learning model includes:
a first learning model that is a first learning model for generating the flow velocity estimation image from the flow velocity image and that is trained based on the loss function using at least the information on the physical law of the fluid and the flow velocity image; and
a second learning model for generating the morphological image from at least one of the flow velocity image or the flow velocity estimation image.

12. The image processing device according to claim 1, wherein:
the structure is a blood vessel, and
the fluid is blood.

13. The image processing device according to claim 12, wherein the blood vessel is at least one of a cerebral artery, a carotid artery, a coronary artery, a thoracic aorta, or an abdominal aorta.

14. The image processing device according to claim 12, wherein the flow velocity image is a three-dimensional image acquired by imaging the blood vessel using a three-dimensional cine phase contrast-magnetic resonance imaging method.

15. The image processing device according to claim 12, wherein the processor is configured to derive a wall shear stress for each region in the morphological image based on the flow velocity estimation image and the morphological image.

16. The image processing device according to claim 15, wherein the processor is configured to generate an image in which magnitude of the wall shear stress for each region in the morphological image is visualized.

17. The image processing device according to claim 12, wherein the processor is configured to:
use the learning model to further generate a pressure image representing a distribution of a pressure of the fluid in the structure from the flow velocity image; and
derive fractional flow reserve for each region in the morphological image based on the pressure image and the morphological image.

18. The image processing device according to claim 17, wherein the processor is configured to generate an image in which magnitude of the fractional flow reserve for each region in the morphological image is visualized.

19. An image processing method executed by a computer, the image processing method comprising: using a learning model that is a learning model for generating, from a flow velocity image representing a spatial distribution of a flow velocity vector of fluid in a structure of a living body, a flow velocity estimation image having a higher resolution than the flow velocity image and a morphological image representing a morphology of the structure and that is trained based on a loss function using at least information on a physical law of the fluid and the flow velocity image, to generate the flow velocity estimation image and the morphological image from the flow velocity image.

20. A non-transitory computer-readable storage medium storing an image processing program causing a computer to execute a process comprising: using a learning model that is a learning model for generating, from a flow velocity image representing a spatial distribution of a flow velocity vector of fluid in a structure of a living body, a flow velocity estimation image having a higher resolution than the flow velocity image and a morphological image representing a morphology of the structure and that is trained based on a loss function using at least information on a physical law of the fluid and the flow velocity image, to generate the flow velocity estimation image and the morphological image from the flow velocity image.
